(19) United States
(12) Patent Application Publication
(10) Pub. No.: US 2008/0093867 A1
(43) Pub. Date: Apr. 24, 2008

(54) B-SHAPED BEAM WITH INTEGRALLY-FORMED RIB IN FACE

(75) Inventors: Scott C. Glasgow, Spring Lake, MI (US); Thomas J. Johnson, Fruitport, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/872,063

(22) Filed: Oct. 15, 2007

Related U.S. Application Data
(60) Provisional application No. 60/862,688, filed on Oct. 24, 2006.

(51) Int. Cl. B60R 19/02; B21B 1/08

(52) U.S. Cl. 293/102; 29/592

(57) ABSTRACT

A B-shaped reinforcement beam is formed from a sheet of material to include vertically spaced upper and lower tubular sections, with a channel-shaped rib formed centrally in the unsupported portion of the front wall over each tube section. The ribs acts to stiffen and stabilize the front wall, causing the actual bending strength of the B beam to be much closer to expected theoretical values. In one form, the ribs have a vertical dimension about 33%-50% of a height of the tubular sections and a depth of about 50%-100% of the rib's height. The rib is particularly effective when the material is less than 2.2 mm, more than 80 KSI, and/or has a significant height-to-depth ratio such as 3:1.

### CROSS REFERENCE TO RELATED APPLICATION

This application claims benefit of a provisional application under 35 U.S.C. § 119(e), Ser. No. 60/862,688, filed Oct. 24, 2006, entitled B-SHAPED BEAM WITH INTEGRALLY-FORMED RIB.

### BACKGROUND

The present invention relates to a B-shaped beam with one or more ribs formed integrally into its front wall over its tube sections for improved actual bending strength, improved front wall stability and overall beam stability, and improved consistency and efficiency of impact energy absorption.

B-shaped bumper reinforcement beams (hereafter called “B beams”) have been used in vehicle bumpers for many years. For example, see Sturrus U.S. Pat. No. 5,395,036, where the B beam's cross section includes relatively flat walls forming two tubes, one spaced above the other when in a vehicle-mounted position. Part of the reason for the success of this B-shaped beam is because, when mounted to a vehicle's frame rail tips, it includes four horizontally oriented walls that provide excellent bending strength and impact resistance in a longitudinal/horizontal direction of impact. However, modern vehicles are being designed with less “package space” for bumpers, and it is becoming increasingly difficult to provide sufficient beam strength and impact resistance when the size and/or depth of a vehicle's front (or rear) bumper beam is limited due to such small “package spaces.” Further, our testing showed that the actual bending strength of B beams like that shown in the Sturrus '036 patent falls surprisingly far below its expected theoretical impact strength. This gap between theoretical and actual impact strength becomes worse for B beams having relatively thin wall thicknesses (especially at 2.2 mm to 1.4 mm or thinner) and when using higher strength steels (such as 80 KSI, 120 KSI or even 190 KSI tensile strengths). Notably, thinner walls and higher strength materials are often used in an effort to reduce a weight of B beams and bumper systems.

Our investigation into this problem showed that a majority of B-shaped bumper reinforcement beams now in production and on passenger vehicles in the U.S. have a vertically-linear front wall, many being very similar to that shown in the Sturrus '036 patent. By “vertically-linear,” we mean that a vertical transverse cross section through the B beam shows the front wall as being vertical and linear. Notably, the term “vertically-linear” as used herein is intended to describe the front wall of a B beam, including the front wall of elongated straight beams or longitudinally swept beams (i.e. beams that are curved to match an aerodynamically-curved front of a vehicle).

In trying to understand the reasons why front walls of “traditional B beams” have a transverse cross section that is vertically-linear, it appears to us that skilled artisans believe there are several reasons not to form any channel or ribs into a face wall of a B beam. We refer to this as “conventional thinking.” For example, conventional thinking is that the front wall of a B beam does not require stabilization, since it is the horizontal walls that primarily provide impact strength and energy absorption. To the extent that the front wall does require some stabilization, conventional thinking appears to be that it is already stabilized by the middle two horizontal walls that engage a center region of a vertically-linear front wall. Further, the unsupported spans of the front wall (i.e., those portions forming a front of the upper and lower tube sections) are very short and do not require stabilization (based on conventional thinking). Still further, under conventional thinking, since the front wall primarily acts to stabilize the front edges of the horizontal walls, a front wall that extends linearly between the top and bottom edges of the horizontal walls would seem to provide more stability to the horizontal walls than if the front wall were deformed to be non-linear. (In other words, if the front wall were deformed to be non-linear, the front wall could “stretch” toward a linear condition during impact, allowing the edges of the horizontal walls to move a small amount and thus potentially causing them to become less stable.) Still further, any additional forming in a B beam adds to process variables and cost. In essence (according to conventional thinking), forming a rib into a front wall would add cost and process complexity without any substantial added benefit in the final product.

There is another more subtle reason not to inwardly deform a front wall of a B beam. The engineering/mathematical formula for calculating a theoretical bending moment “M” suggests that a vertically-linear front wall (where all of the material of the front wall is positioned as far forward as possible, given the restriction on vehicle “package space”) provides a greater bending moment (and hence stiffer beam section) than if some of the front wall is not positioned as far forward as possible. In other words, if the front wall is deformed to include an inward channel-shaped rib, the B beam's bending moment is reduced and in turn the B beam's theoretical stiffness is reduced . . . since some of the front wall's material is moved closer to its center of mass. Thus, for several reasons, it is counterintuitive to inwardly deform a portion of the front wall in a B beam.

### SUMMARY OF THE PRESENT INVENTION

We have dramatically improved the actual impact strengths of the B-shaped beams to be significantly closer to theoretical impact strength values by adding channel-shaped “power” ribs to the unsupported portions of the front wall in the beams. We believe this improvement is dramatic, surprising, and totally unexpected, and that it is extremely valuable to the bumper industry where bending and impact strengths are extremely important based on government and insurance industry bumper test standards. Specifically, our testing shows that B beams with power ribs of the present invention have an improved actual bending strength (versus B beam without power ribs) that is often greater than 10%-20%, which is an unheard of improvement. In some circumstances, the actual bending strength of our inventive B beams with power ribs approach the actual theoretical values, which is also very surprising to us, because B beams with vertically-linear front walls (see Sturrus '036 patent) have tested to have actual bending values that are only about 50%-60% of their theoretical bending values. Amazingly, this improvement can often be accomplished without increase in weight, and further it opens up the ability to use alternative strength materials in B beam bumper systems. This improvement is believed to be particularly important and surprising since B beams have been used as bumper reinforcement beams for years, but to the present inventors' knowledge, without channel-shaped ribs in their front wall.

This dramatic improvement provides increased design flexibility in styling as well as functionality. Specifically, it allows equally strong (or stronger) B beams to be made with a smaller cross-sectional size. For example, this allows a vehicle designer to reduce the “lower offset” (i.e. the distance from a front of a bumper system to a vehicle headlight), thus allowing a more European-styled vehicle (where the bumper “overhang” is much shorter). It also allows the designer to select different materials (e.g. lower cost/lower strength materials), while maintaining a desired beam strength. Alternatively, stronger B beams can be made within a predetermined “same” bumper package space. Thus, existing bumpers can be made stronger without changing vehicle styling and potentially without increasing vehicle weight.

This is based on the discovery that, when B-shaped bumper reinforcement beams are designed with a vertically-linear front wall, a front wall of the beams becomes locally unstable during bending impact, even though their front wall appears adequately supported to those of ordinary skill. Thus, the actual impact strength of B beams having the present inventive face rib(s) are much closer to theoretical impact strength than traditional B beams with flat front wall, even when a vertical span of the unsupported portion of a vertical front wall over each tube in the inventive B beam is only 65 mm to 40 mm, or less.

As discussed below, the present inventive concept of incorporating a channel-shaped rib into the front wall of tubes in a B-shaped bumper reinforcement beam dramatically, surprisingly, and unexpectedly improves actual measured impact strengths in B beams, making the actual impact strengths much closer to theoretical values. Our investigation shows that this is especially true for B beams made from sheet material thicknesses less than about 2.2 mm, and even more true for thicknesses from 1.4 mm down to 1.2 mm or thinner. It is also true for high strength materials, such as steel having a tensile strength of 80 KSI, and is especially of greater than 120 KSI, and especially of greater than 190 KSI. Notably, sheet thicknesses are often decreased and their tensile strengths increased as a way of saving weight while maintaining a high strength. Thus, the present invention, which helps both for thinner sheet materials and higher strength materials, is considered “doubly” important and significant. The decrease is actual bending strength also occurs in B beams having a relatively short front-to-rear dimension and having a taller cross section, where the vertical unsupported span over each tube is from about 45 mm to 60 mm, or greater, and where the front-to-rear depth is only 40 mm. It is contemplated that a scope of the present invention includes all B-shaped bumper reinforcement beams for vehicle bumper systems, whether the two tubes are equal in size and/or shape, and whether a rib (33) is included in one or both tubes. It is contemplated that a scope of the present invention may also be useful in other environments such as door beams, vehicle frame components, and other situations where actual bending/impact strength is important and the type of bending/functional requirement is similar to that of front and rear bumper systems for vehicles.

In one aspect of the present invention; a bumper reinforcement beam adapted for attachment to a vehicle front or rear end and made from a sheet of material includes, when oriented to a vehicle-mounted position, a vertically-extending front wall, two vertically-extending rear walls, a pair of vertically-spaced-apart middle horizontal walls, top and bottom horizontal walls, and mounting brackets secured to the rear walls and adapted for mounting to a vehicle. The top and bottom horizontal walls combine with the middle horizontal walls and the front wall and the rear walls to define an upper tube section and a lower tube section spaced from the upper tube section. A majority of the front wall is vertically-linear in a transverse vertical cross section but includes a longitudinally-extending channel-shaped rib formed integrally into an unsupported portion of the front wall over at least one of the upper and lower tube sections, the rib acting to reinforce and stabilize the front wall and hence acting to generally stiffen and strengthen the B-shaped reinforcement beam during a bending impact.

In a narrower form, both the upper and lower tubular sections have a longitudinal channel formed therein. In still another narrower form, a rib is centrally located over the unsupported front wall of each tube. In still another narrower form, the rib(s) are single ribs that at least about 8 mm deep, or more preferably at least about 10-15 mm deep and at least about 10-15 mm high.

In one type B beam, the tubular sections have a depth dimension that is about 1.5-2.0 times their vertical dimension, and the beam has a total vertical height of about 2.2-2.8 times the height of the individual tube sections. Also, the ribs have a rib height about equal to or slightly greater than the rib depths, the rib height being about 33%-50% of the height of the tubular section.

In another type beam having a high height-to-depth ratio, the tubular sections have a vertical dimension of at least 1.5 times a depth of the tubular sections, and the beam has a vertical total height of at least about 3 times a depth of the tubular sections, and the channel-shaped ribs have a vertical dimension that is at least about ½ to ⅓ of a height of the tubular sections.

In a narrower form, the sheet of material has a thickness of about 2.2 mm or less and a tensile strength of about 40 KSI tensile strength or more (or more preferably has a thickness of about 1.4 mm or less, and a tensile strength of 80 KSI or more; or most preferably has a thickness of about 1.2 mm or less and a tensile strength of 190 KSI or more).

In another aspect of the present invention, a bumper reinforcement beam adapted for attachment to a vehicle front or rear end includes a B-shaped reinforcement beam formed from a sheet of material and including vehicle-attachment mounts on each end and further including, when oriented to a vehicle-mounted position, upper and lower tube sections spaced apart and connected by a center web. The reinforcement beam includes a front wall with portions forming a front part of the upper and lower tube sections, a majority of each of the front wall portions extending vertically in a transverse vertical cross section but including longitudinally-extending channel-shaped ribs formed integrally into the portions centrally over the upper and lower tube section.

In another aspect of the present invention, a method for manufacturing a B-shaped bumper reinforcement beam adapted for attachment to a vehicle front or rear end, comprises steps of providing a sheet of steel material, and rollforming the sheet into a B-shaped reinforcement beam that includes, when oriented to a vehicle-mounted position, top and bottom tube sections connected by a center web. The beam is formed to include a front wall with unsupported portions forming parts of the top and bottom tube sections, with a majority of each of the front wall portions extending vertically in a transverse vertical cross section, but including channel-shaped ribs formed integrally into the vertical portions centrally over the upper and lower tubular sections.

In yet another aspect of the present invention, a bumper beam includes an elongated reinforcement beam with vehicle-attachment mounts on each end and further swept to non-linear shape. The beam, when oriented in a vehicle-mounted position, includes upper and lower tube sections and a front wall with unsupported portions forming a front of the upper and lower tube sections, and further includes a channel-shaped rib in each of the unsupported portions.

The particular appearance of the present B beam in FIGS. 3 and 5-6 are also believed to be novel, ornamental, and unobvious to persons in this art.

These and other aspects, objects, and features of the present invention will be understood and appreciated by those skilled in the art upon studying the following specification, claims, and appended drawings.

### BRIEF DESCRIPTION OF DRAWINGS

FIG. 1 is a prior art illustration taken from Sturrus U.S. Pat. No. 5,395,036, showing a B beam.

FIG. 2 is a perspective view of a first embodiment of the present B-shaped beam.

FIG. 3 is a cross-sectional view taken along line III-III of the B-shaped beam in FIG. 2.

FIG. 4 is a three-point bending test fixture.

FIGS. 5-6 are top and cross-sectional views of a second embodiment B beam with power ribs.

FIG. 7 is a cross section of a prior art B beam similar to the inventive B beam of FIG. 5-6, but having a cross section with a vertically-linear front wall.

FIG. 8 is a graph showing the results of a three-point bending test conducted on the B beams of FIGS. 5-6 (B beam with power ribs) and FIG. 7 (B beam without power rib).

FIG. 9 is a photograph of the top of the straight B-shaped beams after the test shown in FIG. 8, the damage showing a different stress distribution and impact deformation, the B-shaped beam with power rib (shown at a top of the picture) having a wider stress distribution and wider region (less localized region) of impact deformation than the B-shaped beam without power rib (shown at a bottom of the picture). FIG. 9A is a line drawing of FIG. 9.

FIGS. 10-11 are computer-generated front views of the B-shaped beams in FIG. 9, the FIG. 10 showing an FEA analysis of stress distribution during bending of the B-shaped beam with power rib (FIG. 9, top of picture), and the FIG. 11 showing an FEA analysis of stress distribution during bending of the B-shaped beam without power rib (FIG. 9, bottom of picture). FIGS. 10A-11A are line drawings of FIGS. 10-11.

FIG. 12 is a graph of displacement versus bending load comparing test results on a three-point bend test (see FIG. 4) of the B-shaped beam with power rib (see FIGS. 5-6) as compared to a B-shaped beam without power rib (see FIG. 7), the comparison being made using FEA correlation techniques to show weight-equivalent B-shaped beams.

FIG. 13 is a top view photograph of two B-shaped beams (see B beam with power rib in FIGS. 5-6 and B beam without power rib in FIG. 7) after a 5 mph flat barrier physical impact test, the top beam in the photograph being of a B-shaped beam with power rib, and the bottom beam being of a B-shaped beam without power rib.

FIG. 14 is a graph of intrusion distance (movement of a center of the beam toward a vehicle's radiator) versus load, comparing test results of a 5 mph flat barrier physical impact test of the B-shaped beam with power rib and of the B-shaped beam without power rib.

FIG. 15 is a graph of intrusion distance versus load, comparing test results of a 5 mph flat barrier physical impact test of the B-shaped beam with power rib and a standard B-shaped beam without power rib (cross section with vertically-linear front wall), but the data for the B beam with power rib is adjusted (using FEA correlation techniques) to account for a reduced wall thickness in the B beam with power rib so that the B beam with power rib has an equal mass to the illustrated B-shaped beam without power rib.

FIG. 16 is a graph of intrusion distance (rearward movement of the beam during impact) versus load, comparing test results of a 10 km/h IIHS bumper barrier physical impact test of the B-shaped beam with power rib and the B-shaped beam without power rib (i.e., flat face wall).

### PRIOR ART

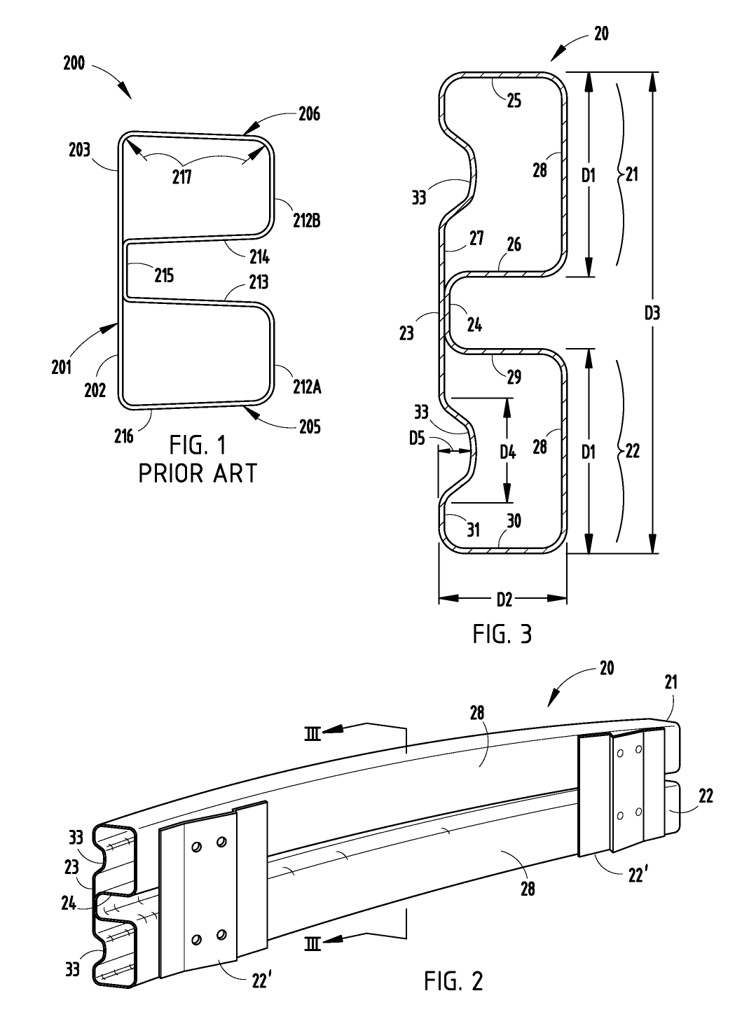

FIG. 1, taken in part from Sturrus U.S. Pat. No. 5,395,036, is exemplary of B-shaped bumper reinforcement beams having a transverse cross section with a vertically-linear front wall. The illustrated B beam 200 in FIG. 1 includes a “vertically-linear” front wall 201 formed by co-planar edge portions (“wings”) 202, 203 welded to a center web 215. It is noted that many B beams include a single continuous portion of sheet forming their entire front wall. In such B beams, the weld(s) is located in another location on the B beam. The B beam in the Sturrus '036 patent includes a cross section with two tubes 205 and 206, one spaced above the other by web 215 when in a vehicle-mounted position, such that four walls (213, 214, 216, 217) extend horizontally from the front wall, with the coplanar walls 212A and 212B closing a rear of the tubes. The B beam in Sturrus is swept (i.e., longitudinally curved), however it is noted that many B beams are straight (i.e., longitudinally linear).

### Detailed Description of Preferred Embodiments

As will be understood by persons skilled in this art, in a pure bending condition, the theoretical beam maximum bending stress is predicted by the following equation: σ=M/Z, where M is the bending moment and Z is the plastic section modulus. When σₘₐₓ≦σ_{yield}, the beam will theoretically not buckle under bending moment M. Therefore just before beam buckle, Mₘₐₓ=σ_{yield}×Z. Mₘₐₓ is often referred to as section flexure rigidity. This theoretical value M must be correlated to actual test results (actual Mₘₐₓ), since actual values vary. For example, as illustrated and discussed hereafter, a ratio of the actual Mₘₐₓ value to the theoretical Mₘₐₓ value can be as low as 50% to 60% in a B beam with a cross section having a vertically-linear front wall, such as the prior art B beam shown in Sturrus U.S. Pat. No. 5,395,036 (see FIG. 1 herein and discussion above).

We have discovered that a ratio of the actual Mₘₐₓ to the theoretical Mₘₐₓ value can be raised to about 70% to 80% or higher in a B beam 20 incorporating an integral channel-shaped reinforcement rib 33 (referred to herein as a “power rib”) into the unsupported portions of an otherwise generally vertically-linear front wall in B beams. Our testing shows that this rib is preferably at least about 8 mm deep, and at least about ⅓ of a height of the unsupported portion of the front wall extending over individual tubular sections. This is considered to be an extra-ordinarily surprising and unexpected result, given that the (vertically-linear) front wall of a B beam is already supported near its center by the middle horizontal walls of a typical B beam. This is especially surprising when the unsupported span in the vertically-linear front wall (i.e., that portion of the front wall that extends across a tube section) in bumper reinforcement beams is typically only about 40 mm to 65 mm, and yet a dramatic improvement in actual bending strength is still achieved. As result of the present inventive concepts, new design choices exist. For example, existing B-shaped bumper reinforcement beams can be reduced in wall thickness (i.e., to save weight while still providing a same impact strength). Alternatively, the impact strength of existing B-shaped bumper reinforcement beam designs can be increased without added weight or cost (i.e., simply by adding the power rib to a flat front wall without changing sheet thickness or part design). Alternatively, new B-shaped bumper reinforcement beams can be designed with thinner front-to-rear dimensions yet with equal strength to other “deeper” designs (thus saving package space at a front of the vehicle and also reducing intrusion distance during an impact).

The illustrated B-shaped bumper reinforcement beam 20 (FIGS. 2-3) is rollformed from a sheet to define a pair of vertically spaced tubes 21 and 22 (when in a vehicle mounted position). The B beam 20 includes a front wall 23 that extends from top to bottom of the beam and that defines a front of each tube. The unsupported front wall portions over each tube are generally vertically-linear and aligned, however the front wall 23 includes a channel-shaped rib 33 located on the front wall centrally over each of the tubes 21 and 22. The ribs 33 stabilize the unsupported front wall portions over each tube in a way that provides improved impact strength, as discussed below. The illustrated rib 33 is formed inwardly so that it does not protrude in front of the front wall of the beam 20. By this arrangement, the rib 33 is not initially impacted by an object (such as a pole or tree). Thus, the ribs 33 are not bent during initial impact, allowing them to stabilize the front wall of the beam for a longer period of time during initial impact. However, in a broadest sense, a scope of the present invention is not believed to be necessarily limited to inwardly-formed ribs (33). Also, the illustrated ribs 33 are centrally formed over each tube 21 and 22, and the illustrated tubes 21 and 22 are similar in size and shape, as are the ribs 33. However, in a broadest sense, a scope of the present invention is also believed to include a B beam where the two tubes are not of equal size and/or shape, and where additional tubes may be present, and where the ribs are not necessarily centrally located over each tube, nor where the ribs are of equal size and shape.

The illustrated B beam 20 of FIGS. 2-3 is preferably formed from a sheet of material, such as 1.0 mm to 2.2 mm steel (or more preferably 1.1 mm to 1.6 mm thick, or most preferably 1.2 mm to 1.4 mm thick, depending on functional requirements of the bumper system). The sheet has a tensile strength of 40 KSI, or preferably 80 KSI, or more preferably 120 KSI (or in some circumstances 190 KSI). The upper and lower tubular sections 21 and 22 are spaced apart and connected by a pair of juxtaposed intermediate vertical walls 23 and 24. The upper tubular section 21 includes horizontal walls 25 and 26 interconnected by front and rear vertical walls 27 and 28. The lower tubular section 22 includes horizontal walls 29 and 30 interconnected by front and rear vertical walls 31 and 32. The illustrated vertical wall 23 is made by coplanar edge portions of the rollformed sheet that are welded at a center location to web 24 to form a “vertically-linear” front wall. However, it is contemplated that the vertical wall 23 could be formed from a continuous single portion of sheet material (in which case edges of the rollformed sheet would be joined in a different area along a perimeter of the B beam). A pair of mounting brackets 22′ are attached to the rear walls 28, 32 near each end. The illustrated mounting brackets each include flanges welded to the swept beam 20 and each bracket further includes coplanar aligned portions with apertures adapted for bolted attachment to a vehicle's frame rails.

In the illustrated arrangement of FIG. 3, the tubular sections 21 and 22 have a vertical dimension D1 of about 1.5 times a depth dimension D2 of the tubular sections. The illustrated beam 20 itself has a vertical total height D3 of about 3-4 times a depth dimension D2 of the tubular sections, and the power ribs have a vertical dimension D4 that is about 33% to 50% of a height of the respective tubular sections and a depth dimension D5 is at least about 10% to 35% (and more preferably about 25%) of the depth dimension D2. The illustrated B beam in FIG. 3 has the following actual dimensions: individual tube height dimension D1 of each tube is about 65 mm, total beam depth dimension D2 is about 40 mm, total beam height dimension D3 is about 150 mm, rib height dimension D4 is about 20 mm to 30 mm, and rib depth dimension D5 is at least about 8 mm (or more preferably 10-15 mm).

It is noted that the present invention of ribs 33 in the unsupported portions of the front wall of B beams is particularly important when B beams are made from thinner material, and/or when made from high strength material, and/or when the B beams cross section has a high height-to-depth ratio. The reason is because B-shaped bumper reinforcement beams are often made “stronger” by using ultra high strength steel, because the material's high yield point enables higher section flexure rigidity. This allows lower thickness materials to be used, saving weight. B beams with high height-to-depth ratios provide a wider impact face while still providing good bending strength. However, it has been observed that in B beams with vertically-linear front walls have increasingly poor actual bending strengths, especially at lower material thicknesses, (such as 2.2 mm or less, and especially at 1.4 mm-1.2 mm or lower thicknesses) and/or at higher material tensile strengths (such as 80 KSI to 190 KSI or higher) and/or with cross sections having high height-to-depth ratios (such as where the beam is 150 mm high, 40 mm deep, each tube height being about 65 mm high and the tubes being spaced about 20 mm apart). In such B beams, our testing shows that the B beam's actual bending strength is substantially below the theoretical bending strength, often only 50%-60% of the theoretical bending strength. This is apparently due in significant part to the local instability of the front wall in unsupported regions of the front wall over each tube in the B beam. This local instability reduces the actual Mₘₐₓ significantly below the expected theoretical value . . . such that the actual strength of these B beam falls to only about 50%-60% of the expected theoretical value.

In the testing described below, the actual Mₘₐₓ value of B beams were raised significantly from about 50%-60% of their theoretical bending strength to about 70%-80% in a B beam having power ribs. In at least one test, the actual bending strength was raised almost to the theoretical bending strength. We believe that this can be explained in part by the different type of failure mode exhibited between the B beam 20 and the prior art beam of Sturrus '036 patent. In B beams having cross sections with vertically-linear front walls (and no “power rib”), the front walls appear to kink and collapse prematurely during an impact due to compressive longitudinal forces developed in the unsupported portions of the front walls, which results in localized instability of adjacent walls and then premature total failure of the beam. Contrastingly, in B beams having cross sections with front walls having power ribs (i.e., channel ribs formed in unsupported front wall portions extending over the tubes), the front walls appear to better resist premature kinking and collapse. This results in a stronger beam (i.e., a B beam having an actual bending strength closer to its theoretical bending strength). Notably, we believe that this premature collapse due to kinking from compressive longitudinal forces is due to a somewhat different failure mode than a theoretical bending failure. Specifically, the theoretical bending strength increases when a beam's bending moment M value increases. However, when material from the front wall is used to form a channel-shaped rib into the face of a beam, it actually decreases the beam's theoretical bending moment since material is moved from the extreme front of the beam (where it contributes a greatest amount toward beam bending strength and bending moment “M”) and is moved toward a center of mass (where it contributes a lesser amount toward the beam's bending strength).

To test the present theory, a three point bending test fixture 300 was used, as shown in FIG. 4. The test fixture 300 included lower supports 301 spaced apart 880 mm and having a curved upper surface 302 for engaging the beam. The test fixture 300 further included an upper head 303 having a lower surface 304 defining a radius for pressing against a center of the beam under test. The beam (illustrated by beam 305) was positioned on the supports 301 for engagement at its mid-point by the upper head 303.

Early experimentation was conducted using two similar beams, one having power ribs (see the B beam 20 with power ribs 33 as shown in FIGS. 2-3) and one not having power ribs. The beams were identical in every aspect except for the power rib (33). Specifically, they were made from exactly the same material coil (i.e. same material properties and thickness), had a same longitudinal curvature, and a same total vertical height and depth. The beam 20 with power rib 33 had a dramatically improved bending strength by about 20% at bending displacements near failure. This was extremely surprising to us.

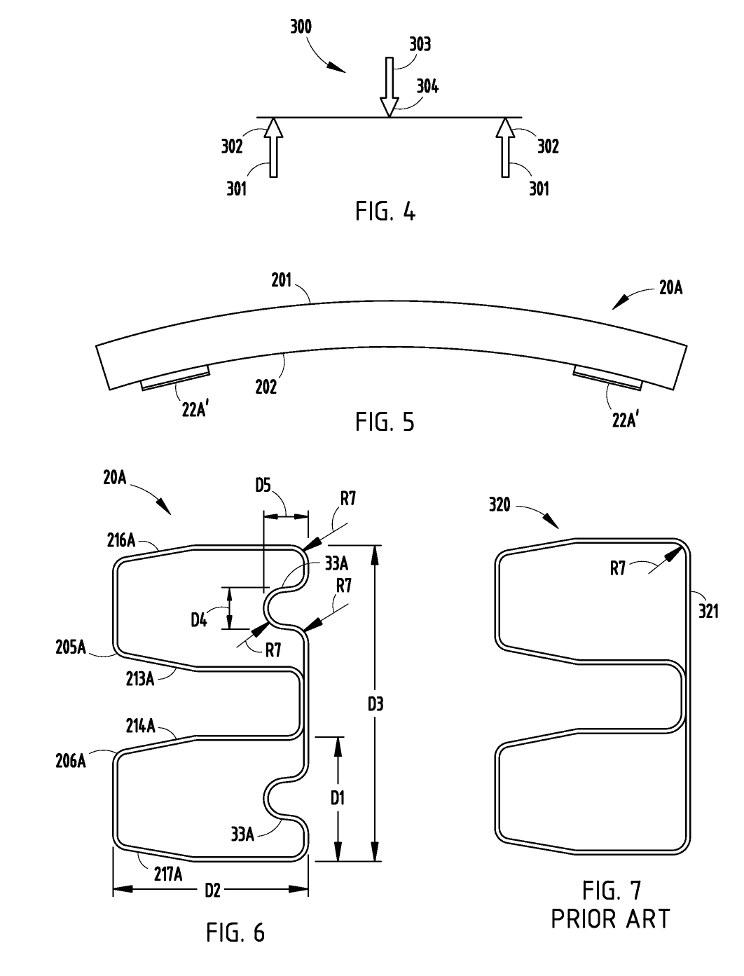

To further test the present concept, a second beam 20A was constructed with power ribs 33A in its front wall 201A over its tubes (FIGS. 5-6) and a second beam 320 was constructed with vertically-linear front wall 321 without power ribs (FIG. 7). The beams 20A and 320 each had a total height of 115 mm, and a total depth of 70 mm, and mounts 22A′ welded to their rear surface. The beams were both made from sheet material having a tensile strength of 190 KSI and a 1.16 mm thickness. The beams 20A and 320 each had top and bottom tubes with a height of 45.5 mm and depth of 70 mm, and that were spaced apart about 24 mm. The top and bottom tubes 205A and 206A define four horizontal walls (213A, 214A, 216A, 217A) (when in a vehicle-mounted position), with each horizontal wall having a slight bend at its mid-point, with the forward half portion of the horizontal walls being relatively parallel and horizontal, and with the rearward half portion of the horizontal walls being tapered inward toward a rear of each tube. In the beam 20A, the front wall had power ribs 33A formed centrally over each tube in the unsupported areas of the front wall, the power ribs each being about 15.49 mm deep and about an equal width of about 15.49 mm (at their mid-depth level). The front wall included a radius R7 of about 7 mm that occurred in several locations, including on the top tube at the upper corner from the top wall onto the front wall, at the upper corner as the front wall transitions into the top power rib 33, at a bottom of the power rib 33, and at a corner from the power rib 33 onto the front wall near the center web. The front wall portion over the bottom tube includes radii R 7 at similar locations as the top tube. As noted above, the beam 320 (FIG. 7) had a cross section with a vertically-linear front wall (i.e., no power ribs). The beam 320 was otherwise similar to beam 20A.

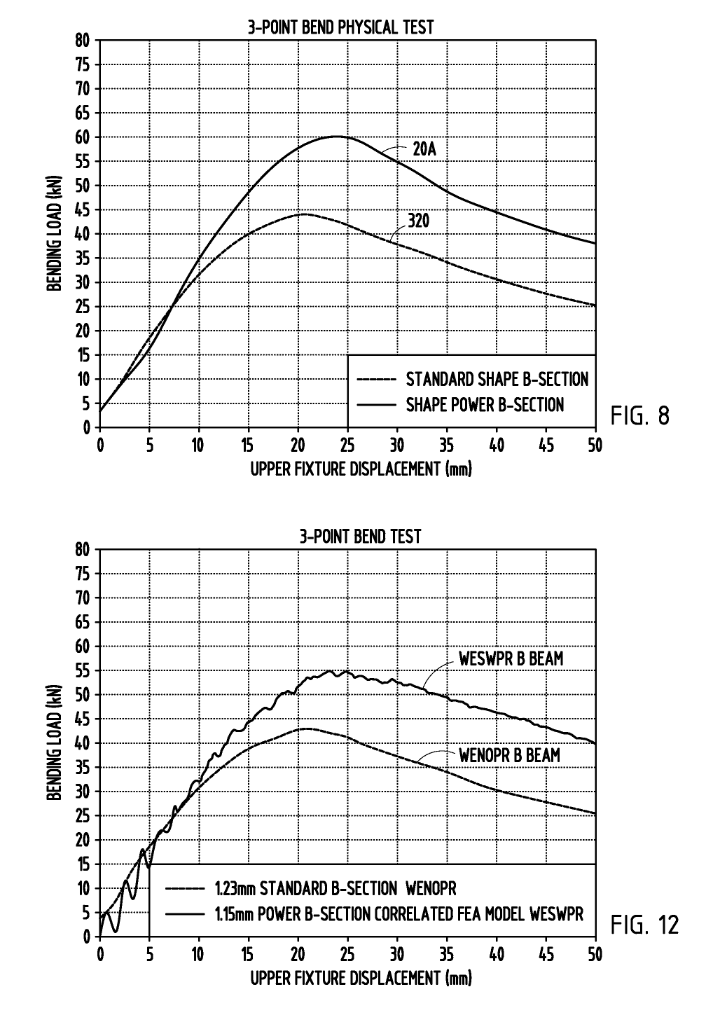

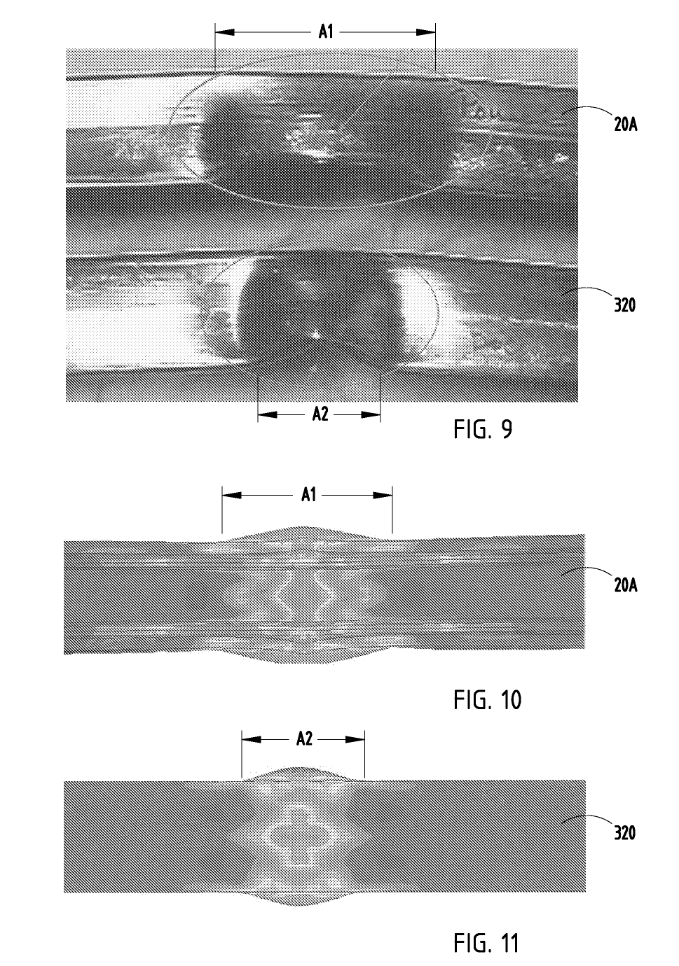

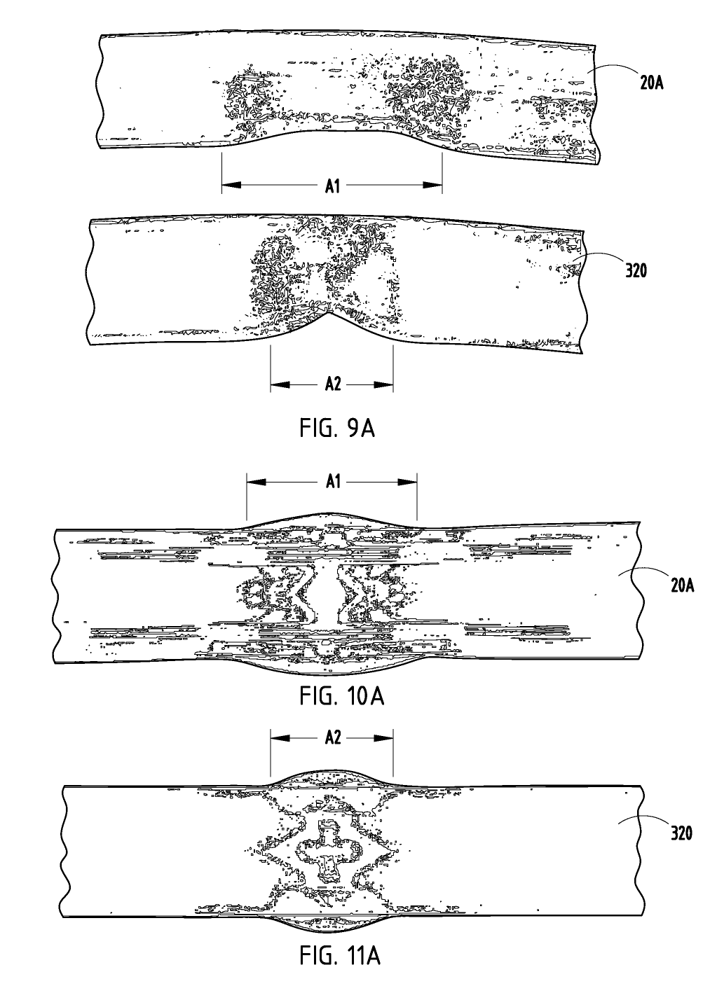

A three-point bend test (see fixture in FIG. 4) was conducted on the swept B section beam 20A with ribs 33A (FIGS. 5-6) and on the swept standard B beam 320 with flat face (without rib) (FIG. 7). In the three-point bend test (FIG. 8), the B beam 20A with power rib 33A gave an improved actual max load=60.2 kN. Contrastingly, the standard shape B-section 320 (without power rib) only gave an actual max load=43.9 9 kN. Also, the B beam 20A with power rib 33A provided a larger deformation area (see upper B beam in the photographs in FIG. 9), while the standard B beam 320 showed evidence of kinking and provided a more localized buckled area (see lower B beam in FIG. 9). This is well-shown by the FEA analysis (see FIGS. 10-11) which gives a visual image of stress representing a three-point bend failure mode. Specifically, stress was distributed over a much large area A1 in the B beam 20A with power rib 33 (FIG. 10), resulting in higher load carrying capacity. Contrastingly, stress was more concentrated in a much more localized area A2 resulting in premature buckling, a sharper buckled point, and a lower load carrying capacity in the B beam 320 with vertically-linear front wall (FIG. 11).

The maximum bending moment was determined on the beams 20A and 320 to better understand the present test results. As noted above, the theoretical maximum bending moment equals the plastic section modulus times the yield strength. (i.e. Mₘₐₓ=Z×YS.) For the B beam 20A, the theoretical Mₘₐₓ=13938 mm³×1224 MPa=17060 Nm. For beam 20A, the actual Mₘₐₓ=PL/4, where P=load, and L=span of test fixture. The actual Mₘₐₓ therefore was (60.2 kN×880 mm/4)=13244 Nm. Therefore, the ratio of the actual/theoretical Mₘₐₓ=(13244/17060)×100%=77.6%. For the B beam 320, the theoretical Mₘₐₓ=13494 mm³×1224 MPa=16517 Nm. For beam 320, the actual Mₘₐₓ=PL/4, where P=load, and L=span of test fixture. The actual Mₘₐₓ therefore was (43.9 kN×880 mm/4)=9658 Nm. Therefore, the ratio of the actual/theoretical Mₘₐₓ=(9658/16517)×100%=58.5%. We conclude that, by decreasing the amount of premature thin wall buckle in the front wall, the B beam 20A with power rib 33A is able to get much closer to the theoretical Mₘₐₓ value than the B beam 320 vertically-linear front wall (i.e., without a power rib). We believe that on thicker beams (i.e. beams with a deeper horizontal section depth), this ratio will go even higher, such as to 85% to 95% or above, due to the type of failure and stresses when bending such beams.

To further illustrate the present inventive concepts, we wanted to compare two B beams of equal weight, one B beam being like B beam 20A with power ribs 33A in its face, and one B beam like B beam 320 having a cross section with a vertically-linear front wall (and no power ribs). Notably, the B beam 20A must be made from a slightly wider sheet since it must include additional material in order to form the channel-shaped power rib 33A. Thus, an “equal weight” B beam 20A requires a thinner wall thickness in order to be equal weight to a B beam 320 with no power rib. We used finite element analysis to generate data for a hypothetical B beam with power rib (identified as a B beam section with power rib, called the “WESWPR B beam”) but having a reduced wall thickness so that it had a same weight as a B beam without power rib (identified as a B beam section with no power rib (called the “WENOPR B beam”). The result was an WESWPR B beam (with power ribs) with a wall thickness of 1.15 mm was a same weight as an WENOPR B beam (no power rib) having a wall thickness of 1.23 mm. We refer to the WESWPR B beam and the WENOPR B beam as “weight equivalent B sections.”

The data in FIG. 12 compares the strength of this hypothetical WESWPR B beam with power rib (i.e., wall thickness 1.15 mm, sheet material of 190 KSI tensile strength) against the WENOPR B beam with linearly-vertical front wall (no power rib, wall thickness of 1.23 mm, 190 KSI tensile strength material). Specifically, the WESWPR B beam had a weight/length of 0.0045 kg, an actual max load of 56.1 kN, and an actual Mₘₐₓ of 12342 Nm. The WENOPR B beam has a weight/length of 0.0045 kg, an actual max load of 43.9 kN, and an actual Mₘₐₓ of 9658 Nm. This shows a surprising 25% or more increase in actual Mₘₐₓ for a WESWPR B beam (with power rib) over an equal-weight WENOPR B beam (no power rib) at significant displacements of over 25 mm.

We also dynamically tested the present inventive B beam. One commonly used dynamic test is known as the “5 mph flat barrier physical impact test.” Such tests are commonly known and do not require a detailed explanation for those skilled in the art of automotive bumper design. Basically a vehicle-simulating wheeled sled supports a bumper system including a B beam attached to its face, and a polymeric energy absorber 345 attached to a front of the B beam. The sled is impacted against a flat barrier while moving at 5 mph. (Alternatively, the sled is stationary, and a pendulum impacts the sled/bumper arrangement at 5 mph.) In the present test, the sled weight (“vehicle mass”) was 1800 kg (60% at the front and 40% at the rear). Another commonly used dynamic test is called the “10 km/h IIHS Bumper Barrier Physical Impact (100% beam to Barrier Overlap).” In this test, bumper B beams are impacted against an obstacle with an impacting structure simulating another bumper. Again, this test is understood by those skilled in the art of bumper design, such that a detailed explanation is not required for an understanding of the test. In our test, a same 1800 kg sled weight was used.

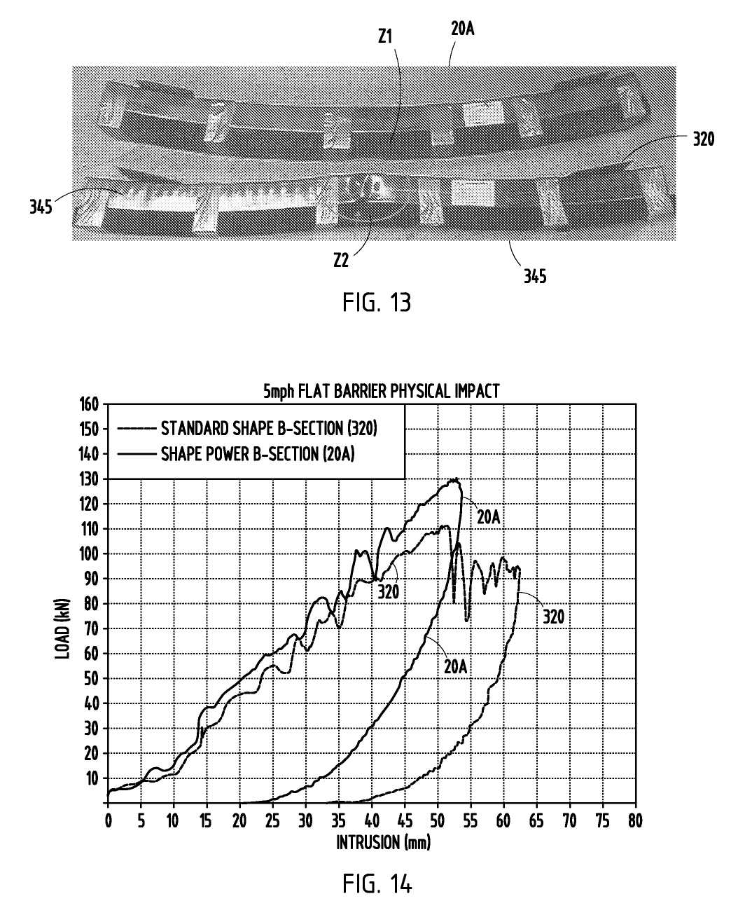

FIG. 13 is a photograph of a B beam 20A with power rib 33A and a B beam 320 without power rib after a 5 mph flat barrier physical impact test, as described above. Both beams 20A and 320 included an identical polymeric energy absorber 345 attached to and abutting their front wall. As can be seen, the 20A B beam with power rib exhibited a distributed impact zone Z1 without any well-defined buckles (see center region). Contrastingly, the B beam 320 with vertically-linear front wall (i.e., no power rib) includes a well-defined buckle near its center at location Z2. This result occurred despite the presence of the polymeric energy absorber on the face of the B beams. Notably, the polymeric energy absorber tens to help soften an impact and spread stress. Yet, the premature buckling problem still occurred in the B beam without rib, and did not occur in the B beam with ribs 33.

FIG. 14 shows the data from the 5 mph flat barrier physical impact test on the beams 20A and 320 shown in FIG. 13. The data shows that the B beam 20A provided a significantly higher impact strength (i.e., about 129 kN total load) than the B beam 320 (which provided a 110.5 kN total load). Also the B beam 20A with power rib had a front face intrusion of 53.8 mm and a back face intrusion of 31.5 mm, while the B beam 320 without power rib had a front face intrusion of 62.2 mm and a back face intrusion of 54.2 mm. It is noted that both beams 20A and 320 were impacted with the same energy. Therefore, as shown by the data, the B beam 20A recovered from its maximum back face intrusion of 53.8 mm to a recovered final position of about 23 mm permanent set . . . while the B beam 320 recovered from its maximum back face intrusion of 62.2 mm to only about 37 mm permanent set.

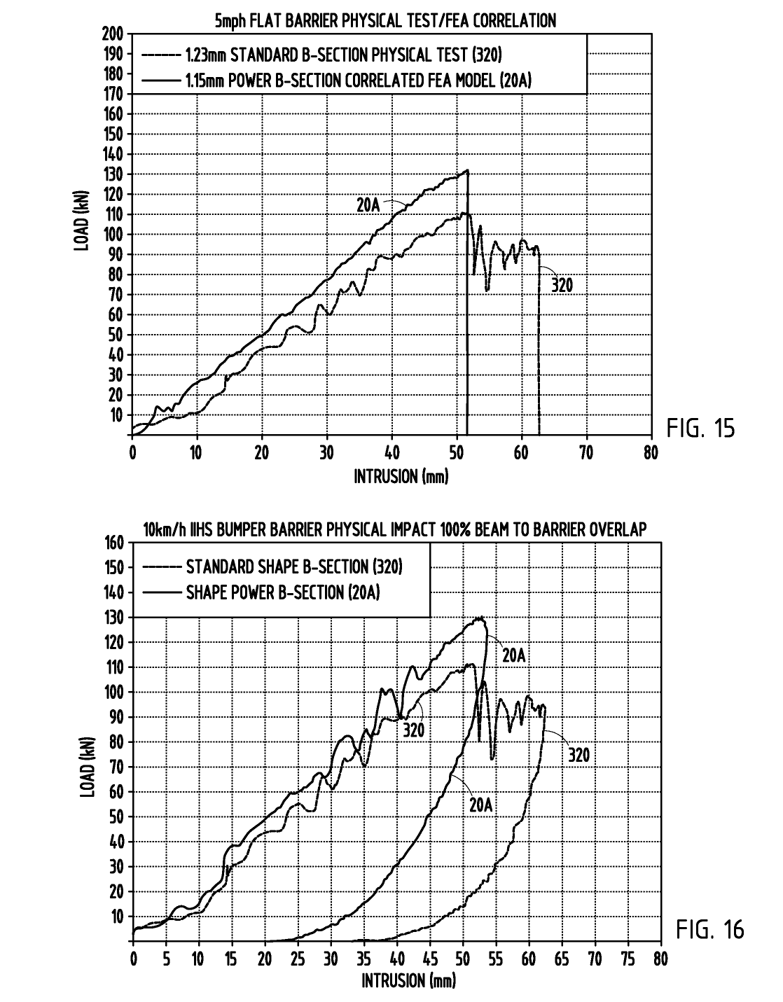

FIG. 15 uses the data from FIG. 14, but is modified using FEA analysis to generate data for comparing weight-equivalent B beams under the 5 mph flat barrier test. In FIG. 15, the B beam (20A) with power rib (using data from the correlated FEA model) had a 1.15 mm thick material, and generated a maximum load of 131.6 kN, a front face intrusion of 51.4 mm, and a back face intrusion of 26.5 mm. Contrastingly, the weight-equivalent B beam (320) without rib had a 1.23 mm thick material, but generated only a maximum load of 110.5 kN, a front face intrusion of 62.2 mm, and a back face intrusion of 54.2 mm. Notably, the B beam 20A had a 49% decrease in back face intrusion using an equal mass beam to the B beam 320.

Also, FIG. 16 shows the results of a test conducted on beams 20A and 320 having an equal wall thickness under the 10 km/h IIHS (Insurance Institute of Highway Safety) Bumper Barrier Physical Impact test with 100% beam to barrier overlap. The B beam 20A with power rib 33A provided a maximum front face intrusion of 111.7 mm, a maximum back face intrusion of 40.4 mm, and a maximum load 131.8 kN. Contrastingly, the standard shape B beam 320 with flat face with equal thickness material provided only a maximum front face intrusion of 121.6 mm, a maximum back face intrusion of 83.2 mm, and a maximum load of 97.6 kN. Thus, the B beam 20A with power rib again significantly outperformed the B beam 320 without power rib (i.e., with vertically-linear front wall).

To summarize, we have discovered that a B-shaped bumper reinforcement beam with power rib in its front wall centered over each of its two tubes has a dramatically and significantly improved actual impact strength as compared to a similar B-shaped bumper reinforcement beam with cross section showing a vertically-linear front wall. The improvement in the B beam with power rib is shown by significantly improved: increased actual bending strength, increased actual dynamic impact strength, photographs showing more distributed deformation at a point of failure and showing greater spread of stress in the beam with power rib, reduced actual back face intrusion, and reduced actual front face intrusion. We conclude that the addition of power ribs in unsupported portions of the front wall over tubes of a B beam is significant. As a result, the actual impact strength of B beams are much closer to theoretical values when power ribs are added. Surprisingly, this is true for B beams having tubes where an unsupported portion of the front wall spans only 40 mm, and is especially true where the material thickness is 2.2 or lower (and especially at 1.4 mm or lower), and when the material strength is above 40 KSI tensile strength (and especially at 80 KSI-190 KSI tensile strengths or greater), and when the rib is at least about 8 mm or more preferably about 10-15 mm.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bumper reinforcement beam adapted for attachment to a vehicle front or rear end, comprising:
a reinforcement beam formed from a sheet of material and including, when oriented to a vehicle-mounted position, a vertically-extending front wall, two vertically-extending rear walls, a pair of vertically-spaced-apart middle horizontal walls, top and bottom horizontal walls, and mounting brackets secured to the rear walls and adapted for mounting to a vehicle; the top and bottom horizontal walls combining with the middle horizontal walls and the front wall and the rear walls to define an upper tube section and a lower tube section spaced from the upper tube section, a majority of the front wall being vertically-linear in a transverse vertical cross section but including a longitudinally-extending channel-shaped rib formed integrally into an unsupported portion of the front wall over at least one of the upper and lower tube sections, the rib acting to reinforce and stabilize the front wall and hence acting to generally stiffen and strengthen the B-shaped reinforcement beam.

2. The bumper beam defined in claim 1, wherein both the upper and lower tube sections have one of the channel-shaped ribs formed therein.

3. The bumper beam defined in claim 2, wherein a single one of the ribs is formed in each of the upper and lower tube sections.

4. The bumper beam defined in claim 3, wherein the top and bottom tubes and also the associated ribs generally have an equal size and shape.

5. The bumper beam defined in claim 3, wherein a top one of the ribs is centrally positioned over the upper tube section.

6. The bumper beam defined in claim 2, wherein the tube sections, when in a vehicle-mounted position, each have a horizontal dimension of at least about 1.5 times a vertical depth of the tube sections.

7. The bumper beam defined in claim 2, wherein the channel-shaped ribs each have a vertical dimension that is about 33% to 50% of a height of the associated tube sections.

8. The bumper beam defined in claim 2, wherein the channel-shaped ribs have a depth dimension that is about equal to a height of the channel-shaped ribs.

9. The bumper beam defined in claim 1, wherein a material tensile strength of the material is greater than 80 KSI.

10. The bumper beam defined in claim 9, wherein the material tensile strength is greater than 120 KSI and a thickness is less than about 2.2 mm.

11. The bumper beam defined in claim 1, wherein a material thickness of the sheet is less than about 1.4 mm.

12. The bumper beam defined in claim 1, wherein the front wall portions have a vertical span of more than about 40 mm, and the rib defines a vertical distance of more than about 15 mm and a depth of more than about 8 mm.

13. The bumper beam defined in claim 1, wherein the beam is swept.

14. A bumper reinforcement beam adapted for attachment to a vehicle front or rear end, comprising:
a B-shaped reinforcement beam formed from a sheet of material and including vehicle-attachment mounts on each end and further including, when oriented to a vehicle-mounted position, upper and lower tube sections spaced apart and connected by a center web, the reinforcement beam including a front wall with portions forming a front part of the upper and lower tube sections, a majority of each of the front wall portions extending vertically in a transverse vertical cross section but including longitudinally-extending channel-shaped ribs formed integrally into the portions centrally over the upper and lower tube sections.

15. The bumper beam defined in claim 14, wherein the center web is aligned with the front wall portions.

16. The bumper beam defined in claim 14, wherein the channel-shaped ribs have a vertical dimension that is at least about 33% of a height of the tube sections.

17. The bumper beam defined in claim 14, wherein a material tensile strength of the material is greater than 80 KSI.

18. The bumper beam defined in claim 17, wherein the material tensile strength is greater than 120 KSI.

19. The bumper beam defined in claim 14, wherein a material thickness of the sheet is less than about 1.4 mm.

20. The bumper beam defined in claim 14, wherein the front wall portions have a vertical span of more than about 40 mm, and the rib defines a vertical distance of more than about 15 mm and a depth of more than about 8 mm.

21. A bumper beam comprising:
An elongated reinforcement beam with vehicle-attachment mounts on each end and further swept to non-linear shape; the beam, when oriented in a vehicle-mounted position, including upper and lower tube sections and a front wall with unsupported portions forming a front of the upper and lower tube sections and further including a channel-shaped rib in each of the unsupported portions.

22. A method for manufacturing a B-shaped bumper reinforcement beam adapted for attachment to a vehicle front or rear end, comprising steps of:
providing a sheet of steel material;
roll-forming the sheet into a B-shaped reinforcement beam that includes, when oriented to a vehicle-mounted position, top and bottom tube sections connected by a center web; the beam including a front wall with portions forming parts of the top and bottom tube sections, with a majority of each of the front wall portions being vertically-linear in a transverse vertical cross section but including channel-shaped ribs formed integrally into the vertical portions centrally over the upper and lower tubular sections.

23. The method defined in claim 22, wherein the step of roll-forming the sheet includes forming the front wall portions to have a vertical span of at least about 40 mm, and the rib to define a depth of more than about 8 mm.

24. The method defined in claim 23, wherein the step of forming the front wall portions includes forming the ribs to each define a vertical distance of more than about 15 mm.
